(19) United States
(12) Patent Application Publication
(10) Pub. No.: US 2020/0232584 A1
(43) Pub. Date: Jul. 23, 2020

(54) HOSE STRUCTURE

(71) Applicant: Newbud Industrial Corp., CHANG HUA HSIEN (TW)

(72) Inventor: Tsang-Fu Liang, CHANG HUA HSIEN (TW)

(21) Appl. No.: 16/399,606

(22) Filed: Apr. 30, 2019

(30) Foreign Application Priority Data
Jan. 17, 2019 (TW) 108101845

(51) Int. Cl. F16L 11/08

(52) U.S. Cl. CPC F16L 11/085

(57) ABSTRACT

A hose has an inner tube and a woven outer tube wrapping the inner tube. The inner tube is made of plastic or rubber. The woven outer tube is braided with a gallop knitting method around the inner tube. The hose is soaked in an adhesive agent to form an adhesive layer between the inner tube and the woven outer tube. The hose is treated with a rolling process by a plurality of rollers to compress the woven outer tube onto the inner tube. Furthermore, after a drying period, the adhesive agent forms as an anti-scratch layer on the woven outer tube. An end of the hose is coupled to a connecting member, and the connecting member further comprises a tightening tube jacketed onto the woven outer tube.

### BACKGROUND of INVENTION

### Field of Invention

The present invention relates to a hose structure, and more particularly to a hose with a stronger structure.

### Description of the Related Art

A hose is known, as shown in FIGS. 8, 9, 10, and 11, the hose 20 includes an elastic inner tube 21 and a woven outer tube 22 overlying on the inner tube 21, and the woven outer tube 22 protects the inner tube 21 to prolong the life of the hose 20.

However, the woven outer tube 22 of the hose 20 is not tightly wrapped around the inner tube 21, so that the inner tube 21 is easily bent by the winding of the woven outer tube 22 and might not be able to be elastically restored, and the diameter of the inner tube 21 is reduced. Furthermore, the woven outer tube 22 is not attached onto the inner tube 21, and the woven outer tube 22 does not deform as the inner tube 21, so it is difficult to detect that the inner tube 21 has formed a bent and blocked state, resulting in being unsmooth water supply.

In addition, the woven outer tube 22 forms a loose covering state with the elastic inner tube 21, if the woven outer tube 22 is wore out after a long time or is cut by a sharp object, the woven outer tube 22 becomes loose, which causes the inner tube 21 to be exposed without protection.

On the other hand, since the woven outer tube 22 is woven from the yarn fiber, when the hose 20 is dragged on the ground during use, it can easily attract sand to the uneven surface of the fiber. Therefore, the hose can get stained and wore out, and the woven outer tube 22 absorbs water and causes moldy, stinky or spoiled due to bacterial growth.

Referring to FIGS. 12, 13, and 14, in another conventional hose structure, the hose 30 includes an inner tube 31, a braid layer 32 overlying the inner tube 31. The outer layer 33 of the braided layer 32 is used to limit the state of the inner tube 31 when it is stretched, so the bending deformation of the inner tube 31 is avoided, and the outer tube 33 is re-pressed to cover outside of the braid layer 32. The braid layer 32 is tightened to the outer diameter of the inner tube 31, while the braid layer 32 is protected by the outer tube 33 to prevent the sharp object from contacting and cutting.

However, although the hose 30 can prevent the inner tube from being jammed, the operation of covering braid layer 32 with the outer layer 33 is extremely laborious. When the mesh density is small, it can increase the structural strength, and also increase the thickness and weight of the hose 30, which makes the hose 30 difficult to be storage. In addition, when the hose 30 is cut by sharp objects, the weaving thread of the braid 32 is also cut which forms a loose off-line condition, causing the elasticity of the inner tube 21 to be exposed without a protective effect, thereby reducing the service life of the structure.

Therefore, it is desirable to provide a speed switching structure for a hose structure to mitigate and/or obviate the aforementioned problems.

### SUMMARY OF THE INVENTION

An objective of present invention is to provide a hose structure, which is capable of improving the above-mention problems.

In order to achieve the above mentioned objective, a hose has an inner tube and a woven outer tube wrapping the inner tube. The inner tube is made of plastic or rubber. The woven outer tube is braided with a gallop knitting method around the inner tube. The hose is soaked in an adhesive agent to form an adhesive layer between the inner tube and the woven outer tube. The hose is treated with a rolling process by a plurality of rollers to compress the woven outer tube onto the inner tube. Furthermore, after a drying period, the adhesive agent forms as an anti-scratch layer on the woven outer tube. An end of the hose is coupled to a connecting member, and the connecting member further comprises a tightening tube jacketed onto the woven outer tube.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view of the preferred embodiment according to the present invention.

FIG. 3 is a schematic view showing the operation of the adhesive agent of the preferred embodiment according to the present invention.

FIG. 4 is a cross-sectional view of the preferred embodiment according to the present invention.

FIG. 5 is a cross-sectional view showing the preferred embodiment being bent according to the present invention.

FIG. 6 is a schematic view of the preferred embodiment being cut by sharp objects according to the present invention.

FIG. 7 is a schematic view showing the woven outer tube of the preferred embodiment not being scattered after being cut by sharp objects according to the present invention.

FIG. 8 is an exploded view of the prior art.

FIG. 9 is a schematic diagram of the bent state of the prior art.

FIG. 10 is a schematic diagram showing the prior art woven outer tube cut by sharp objects.

FIG. 11 is a schematic diagram of the prior art inner tube being bent.

FIG. 12: is another exploded view of the prior art.

FIG. 13 is a cross-sectional view of another prior art.

FIG. 14 is a schematic view of another prior art braided layer being cut by sharp objects.

### DETAILED DESCRIPTION OF THE PREFERRED EMBODIMENT

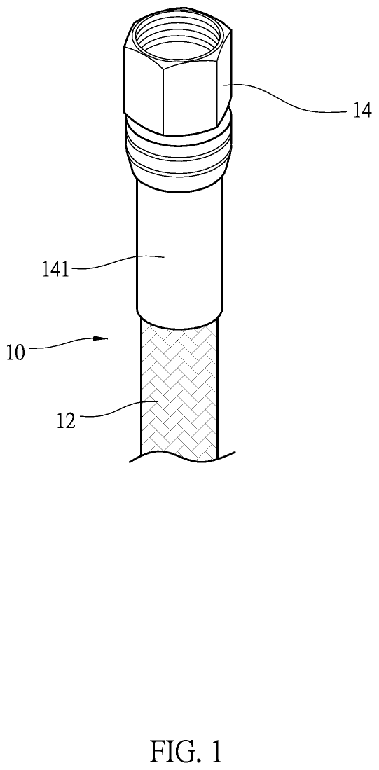

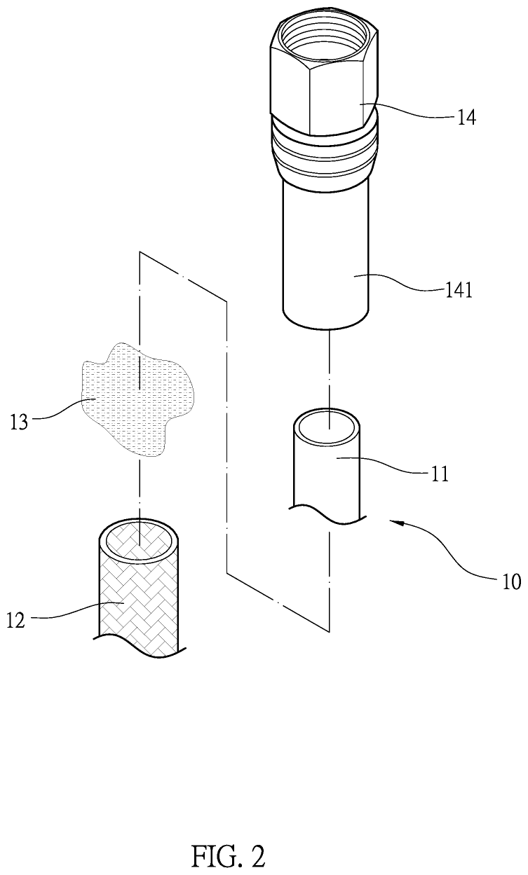

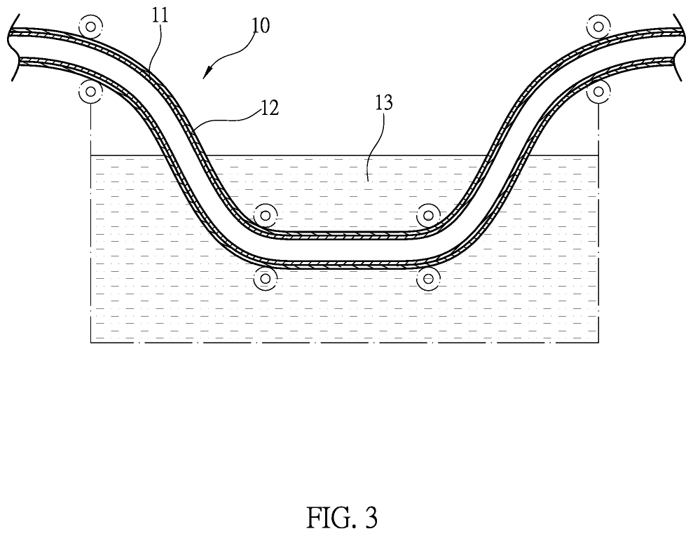

First, please refer to FIGS. 1-4. A hose 10 comprises an inner tube 11 and a woven outer tube 12 wrapping the inner tube 11. The inner tube 11 is made of plastic or rubber. The woven outer tube 12 is braided with a gallop knitting method around the inner tube 11. The hose is soaked in an adhesive agent 13 to form an adhesive layer 131 between the inner tube 11 and the woven outer tube 12. The hose 10 is treated with a rolling process by a plurality of rollers to compress the woven outer tube 12 onto the inner tube 11. Furthermore, after a drying period, the adhesive agent forms as an anti-scratch layer 132 on the woven outer tube 12. An end of the hose 10 is coupled to a connecting member 14, and the connecting member 14 further comprises a tightening tube 141 jacketed onto the woven outer tube 12.

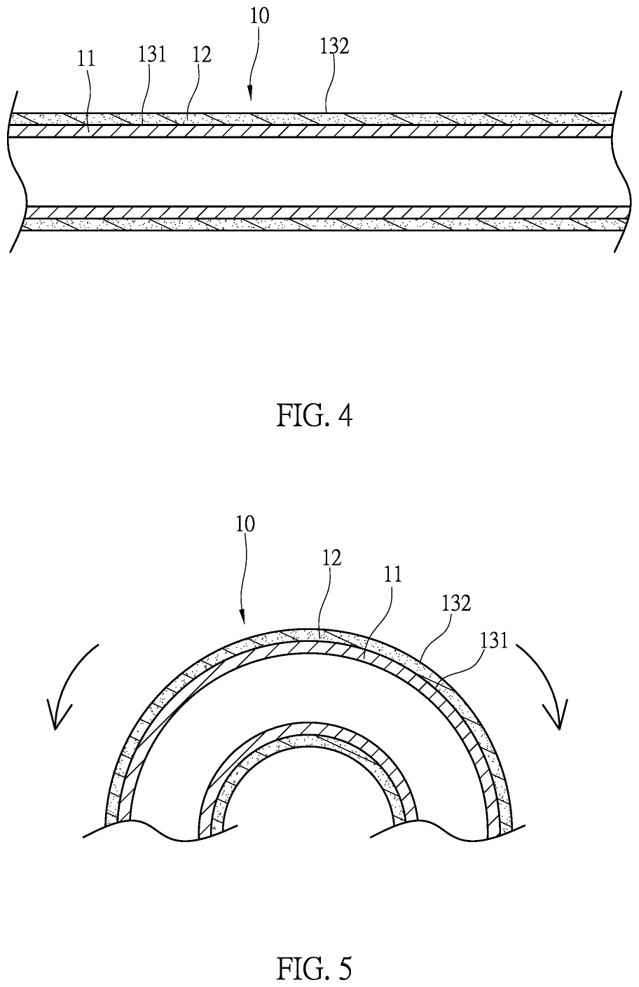

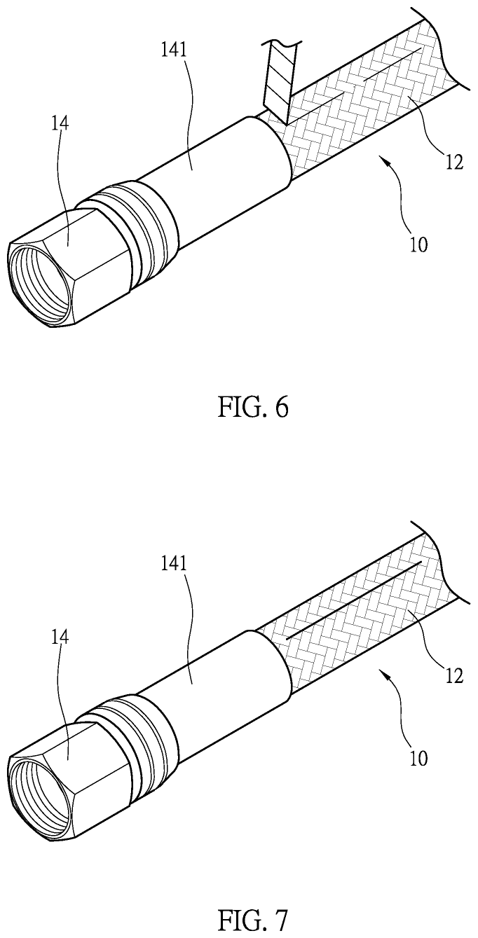

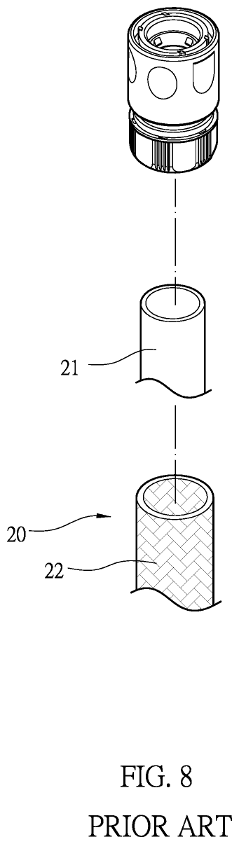

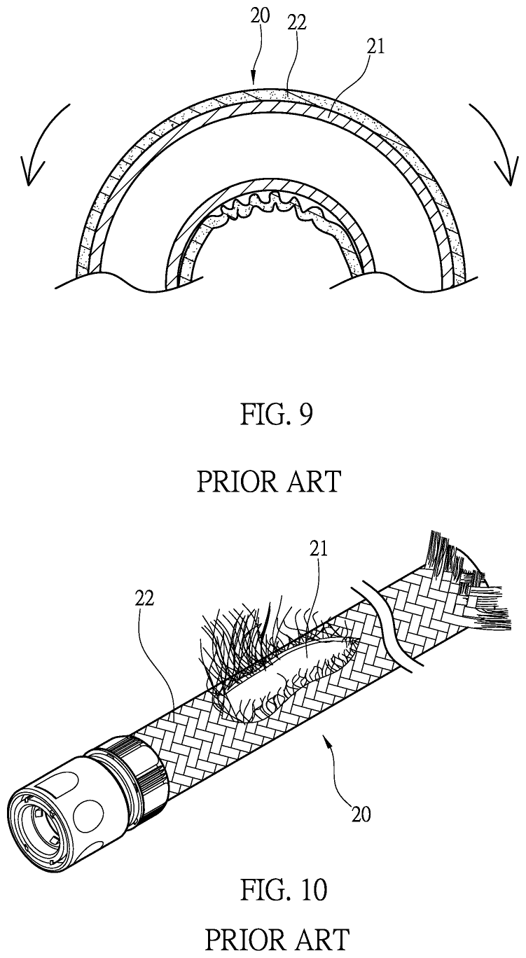

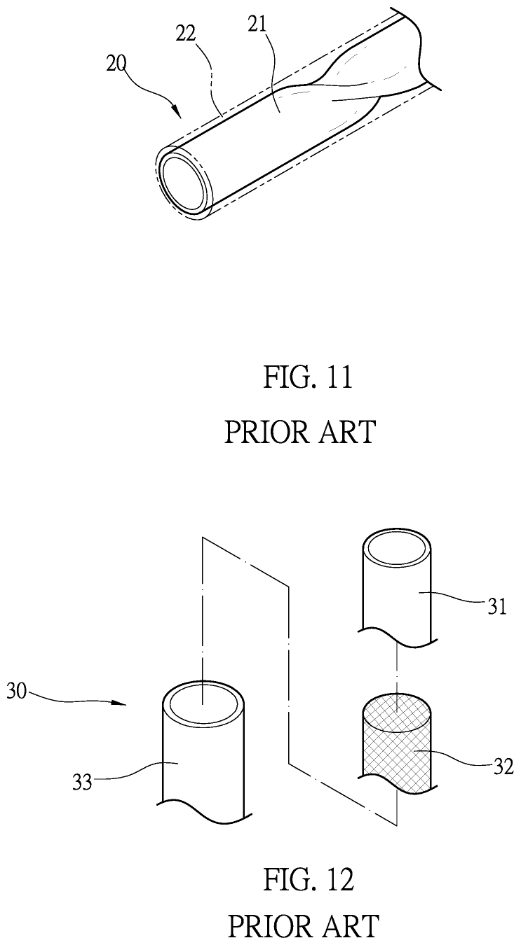

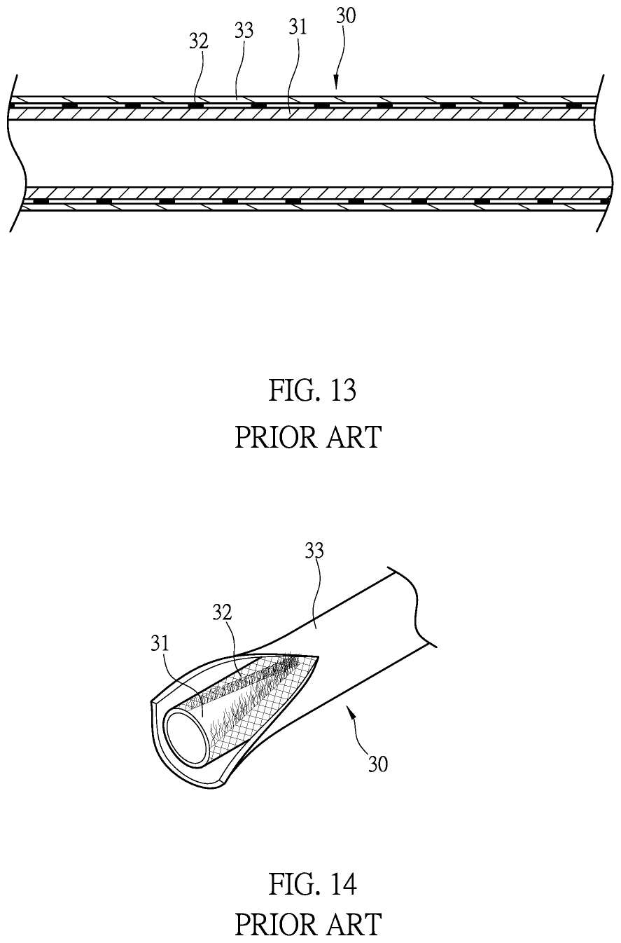

For the application and benefits, please refer to FIGS. 4-7. The hose 10 is used for connection to a water source for water supply. Since the inner tube 11 and the woven outer tube 12 of the hose 10 are combined with the adhesive agent 13 and the pressurized operation, the inner tube 11 is secured onto the inner periphery of the woven outer tube 12, which can be completed at a relatively low cost. Moreover, the inner tube 11 does not get detached from the woven outer tube 12 while the hose 10 is winded, so the inner tube 11 is prevented from being bent in the woven outer tube 12 to cause a narrowing and blocking effect to the flow passage. Therefore, the flatness between the woven outer tube 12 and the inner tube 11 is maintained, which improves the fluency of the water supply. On the other hand, the woven threads of the woven outer tube 12 stick to each other tightly by the immersion of the adhesive agent 13, and the pores on the surface of the woven outer tube 12 are filed by the adhesive agent 13 and forms the hard anti-scratch layer 132 which increases the wear resistance and compression resistance of the hose 10. When the hose 10 is dragged on the ground or cut by sharp objects, the woven outer tube 12 is free from being unthreaded or loosened to ensure the durability of the woven outer tube 12, thereby protecting the inner tube 11. In addition, the anti-scratch layer 132 can also isolate the woven outer tube 12 from adsorbing moisture, so that dirty water does not penetrate into the woven outer tube 12. Therefore, the hose 10 is resistant to dirt, bacteria and is easy to clean after use.

Although the present invention has been explained in relation to its preferred embodiment, it is to be understood that many other possible modifications and variations can be made without departing from the spirit and scope of invention as hereinafter claimed.

What is claimed is:

1. A hose structure comprising an inner tube and a woven outer tube wrapping the inner tube, the hose being soaked in an adhesive agent to form an adhesive layer between the inner tube and the woven outer tube, and an anti-scratch layer disposed on the woven outer tube.

2. The hose structure as claimed in claim 1, wherein an end of the hose is coupled to a connecting member, and the connecting member further comprises a tightening tube jacketed onto the woven outer tube.

3. The hose structure as claimed in claim 1, wherein the woven outer tube is braided with a gallop knitting method around the inner tube.

4. The hose structure as claimed in claim 1, wherein the adhesive agent is a waterproof resin.

5. The hose structure as claimed in claim 1, wherein the hose is treated with a rolling process by a plurality of rollers to compress the woven outer tube onto the inner tube.

6. The hose structure as claimed in claim 1, wherein tension from the woven outer tube warps the inner tube.

7. The hose structure as claimed in claim 1, wherein the inner tube is a plastic tube.

8. The hose structure as claimed in claim 1, wherein the inner tube is a rubber tube.
